(19) United States
(12) Patent Application Publication
(10) Pub. No.: US 2025/0303699 A1
(43) Pub. Date: Oct. 2, 2025

(54) IMAGE FORMING APPARATUS

(71) Applicant: KYOCERA Document Solutions Inc., Osaka (JP)

(72) Inventor: Koji Kusumoto, Osaka (JP)

(21) Appl. No.: 19/073,936

(22) Filed: Mar. 7, 2025

(30) Foreign Application Priority Data
Mar. 26, 2024 (JP) 2024-048955

(51) Int. Cl. B41J 2/045

(52) U.S. Cl. CPC B41J 2/0457; B41J 2/04528; B41J 2/04548; B41J 2/0455; B41J 2/04555; B41J 2/04563; B41J 2/04581

(57) ABSTRACT

An image forming apparatus includes a recording head and a host control system. The recording head eject inks. The host control system controls the recording head. The recording head includes a heater, a temperature sensor, a switching element on a power line to the heater, and a controller configured to control the switching element on the basis of a measurement temperature of the temperature sensor and thereby control temperature of the recording head. Further, the host control system includes a current detection unit configured to detect a current that flows in the power line, a system-side switching element arranged on upstream side of the power line from the switching element, and a main controller configured to cut off the current using the system-side switching element if a continuous current flow time of the current detected by the current detection unit exceeds a predetermined value.

### CROSS-REFERENCE TO RELATED APPLICATIONS

This application relates to and claims priority rights from Japanese Patent Application No. 2024-048955, filed on Mar. 26, 2024, the entire disclosures of which are hereby incorporated by reference herein.

### BACKGROUND

### 1. Field of the Present Disclosure

The present disclosure relates to an image forming apparatus.

### 2. Description of the Related Art

In an inkjet-type image forming apparatus, a heater is installed in a recording head, and temperature management of ink ejection nozzles is performed using the heater.

In the recording head, in order to make a temperature of the recording head identical to a target temperature, it can be supposed to install temperature sensor such as thermistor and a controller that controls a switching element on the basis of a measurement temperature of the temperature sensor and thereby adjusts a temperature of the recording head.

However, if malfunction occurs on any of these elements: the temperature sensor, the switching element, and the controller, then electric power is continuously supplied to the heater and thereby temperature of the recording head abnormally increases.

### SUMMARY

An image forming apparatus according to an aspect of the present disclosure includes a recording head and a host control system. The recording head is configured to eject ink. The host control system is configured to control the recording head. The recording head includes a heater, a temperature sensor, a switching element on a power line to the heater, and a controller configured to control the switching element on the basis of a measurement temperature of the temperature sensor and thereby control temperature of the recording head. Further, the host control system includes a current detection unit configured to detect a current that flows in the power line, a system-side switching element arranged on upstream side of the power line from the switching element, and a main controller configured to cut off the current using the system-side switching element if a continuous current flow time of the current detected by the current detection unit exceeds a predetermined value.

These and other objects, features and advantages of the present disclosure will become more apparent upon reading of the following detailed description along with the accompanied drawings.

### BRIEF DESCRIPTION OF THE DRAWINGS

FIG. 1 shows a diagram that indicates a configuration of an image forming apparatus according to an embodiment of the present disclosure; and

FIG. 2 block diagram that indicates an shows a electronic configuration of the image forming apparatus 10 in the embodiment according to the present disclosure.

### DETAILED DESCRIPTION

Hereinafter, an embodiment according to an aspect of the present disclosure will be explained with reference to drawings.

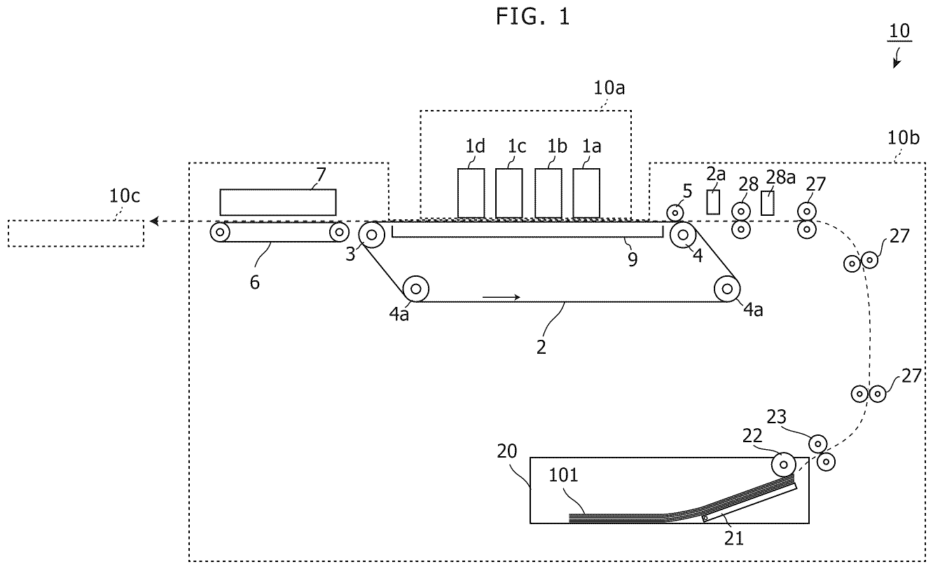

FIG. 1 shows a diagram that indicates a configuration of an image forming apparatus according to an embodiment of the present disclosure. The image forming apparatus 10 shown in FIG. 1 is an apparatus such as printer, copier, facsimile machine or multi function peripheral, and includes an inkjet color printing mechanism of a line head type in this embodiment.

The image forming apparatus 10 shown in FIG. 1 includes a print engine 10a and a sheet transportation unit 10b. The print engine 10a causes ink to adhere to a print sheet 101 as a recording medium, and thereby physically prints an image to be printed on the print sheet 101. For example, an ink cartridge is enabled to be mounted and demounted to and from the print engine 10a, and the print engine 10a performs printing using ink supplied from the ink cartridge. Further, the sheet transportation unit 10b transports to the print engine 10a the print sheet 101.

In this embodiment, the print engine 10a includes line-type recording heads 1a to 1d corresponding to four ink colors: Cyan, Magenta, Yellow, and Black. Each of the recording heads 1a to 1d ejects ink of the corresponding color and thereby forms an image to be printed on the print sheet 10 of a certain type. If this image forming apparatus is a monochrome one, then the image forming apparatus includes a single recording head.

Further, in this embodiment, the sheet transportation unit 10b includes (a) a circular-type transportation belt 2 that is arranged so as to be opposite to the print engine 10a and transports a print sheet, (b) a driving roller 3, a driven roller 4, and a tension roller 4a around which the transportation belt 2 is hitched, (c) a nipping roller 5 that nips the print sheet with the transportation belt 2, (d) a post-stage transportation belt 6, and (e) a dryer device 7.

The driving roller 3, the driven roller 4, and the tension roller 4a cause the transportation belt 2 to rotate. The nipping roller 5 nips an incoming print sheet 101 transported from a sheet feeding cassette 20 mentioned below, and the nipped print sheet 101 is transported by the transportation belt 2 to printing positions of the inkjet recording units 1a to 1d in turn, and on the print sheet 101, images of respective colors are printed by the inkjet recording units 1a to 1d. In this situation, the passing print sheet 101 is detected by a sheet sensor 2a, and a current position of the print sheet 101 on a transportation path is determined on the basis of a detection timing by the sheet sensor 2a, and thereby an image is printed at a proper position on the print sheet 101. Subsequently, the print sheet 101 after printing is outputted by the post-stage transportation belt 6 to an output tray 10c or the like. In this process, the print sheet 101 on which the ink has been ejected is dried by the dryer device 7. Further, sheet suction units 9 are arranged along the transportation path of the print sheet 101. A negative pressure is applied to the sheet suction units 9, and thereby the print sheet 101 is adsorbed to the transportation belt 2.

Further the sheet transportation unit 10b includes a sheet feeding cassette 20 as a sheet supply source. The sheet feeding cassette 20 stores print sheets 101, and pushes up the print sheets 101 using a lift plate 21 so as to cause the print sheets 101 to contact with a pickup roller 22. The print sheets 101 put on the sheet feeding cassette 20 are picked up to a sheet feeding roller 23 by the pickup roller 22 sheet by sheet from the upper side. The sheet feeding roller 23 transports the print sheets 101 sheet by sheet fed by the pickup roller 22 from the sheet feeding cassette 20 onto a transportation path.

A transportation roller 27 transports the print sheet 101 on a predetermined transportation path. A registration roller 28 temporarily stops the print sheet 101 when the incoming print sheet 101 in transportation is detected by a registration roller 28a, and transports this print sheet 101 to the print engine 10a at a secondary sheet feeding timing.

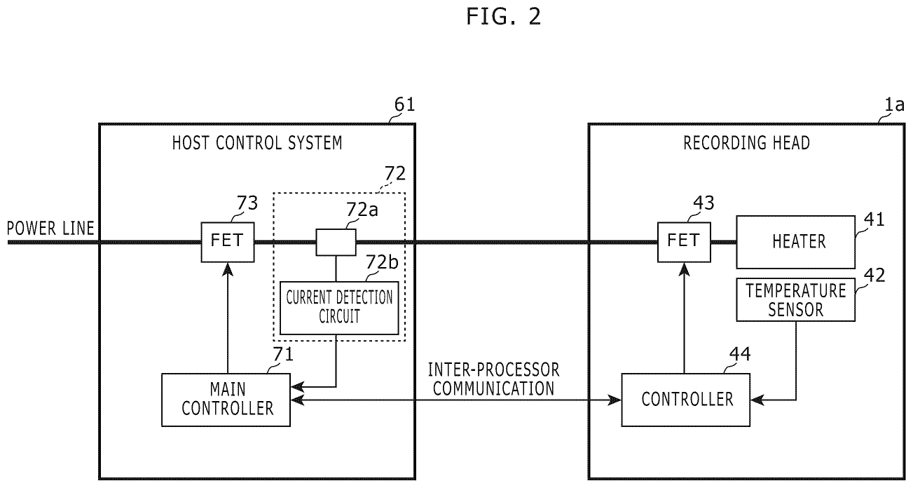

FIG. 2 shows a block diagram that indicates an electronic configuration of the image forming apparatus 10 in the embodiment according to the present disclosure. As shown in FIG. 2, for example, the image forming apparatus 10 further includes a host control system 61 that controls the recording heads 1a to 1d. It should be noted that for explanation, FIG. 2 depicts only recording head 1a, but the recording heads 1b to 1d includes the same configuration.

The recording head 1a includes a head and a driving circuit. The head includes a nozzle that ejects ink, and a piezoelectric element that ejects ink correspondingly to a driving voltage. The ink is supplied from an ink tank to the head. The driving circuit applies a driving voltage to the piezoelectric element and thereby causes it to eject ink.

Further, as shown in FIG. 2, for example, the recording head 1a includes a heater 41 such as resistor, a temperature sensor 42 such as thermistor, a switching element 43 on a power line to the heater 41, and a controller 44. Here, the switching element 43 is a field effect transistor. Further, the controller 44 performs on/off control of the switching element 43 on the basis of a measurement temperature of the temperature sensor 42 and thereby performs a temperature adjustment of the recording head 1a. In the temperature adjustment, the switching element 43 is controlled in an on/off control manner such that the measurement temperature agrees with a predetermined target temperature (here, such that it falls into a predetermined temperature range).

Here, the controller 44 is a processor such as CPU (Central Processing Unit) that executes a control program, a digital analog converter is installed between the controller 44 and the switching element 43, and an analog digital converter is installed between the temperature sensor 42 and the controller 44.

Further, as shown in FIG. 2, for example, the host control system 61 includes a main controller 71 that performs ink ejection control of the recording heads 1a to 1d, a current detection unit 72, and a system-side switching element 73.

The current detection unit 72 detects a current that flows in the aforementioned power line. Here, the current detection unit 72 includes a current detection resistor 72a, and a detection circuit 72b that detects current flow in the power line on the basis of a voltage between both ends of the current detection resistor 72a.

The system-side switching element 73 is arranged on an upstream side of the power line from the switching element 43. Here, the switching element 73 is a field effect transistor.

Further, the main controller 71 watches whether current flow appears on the aforementioned power line or not using the current detection unit 72, and if a continuous current flow time of the current flow detected by the current detection unit 72 exceeds a predetermined value, then the main controller 71 cuts off the current flow to the recording head 1a using the system-side switching element 73. For example, this predetermined value is set correspondingly to an upperlimit temperature allowed for the ink in the recording head 1a.

Here, the main controller 71 is a processor such as CPU that executes a control program, a digital analog converter is installed between the main controller 71 and the system-side switching element 73, and an analog digital converter is installed between the current detection unit 72 and the main controller 71.

The following part explains a behavior of the image forming apparatus 10.

In a normal status, in each of the recording heads 1a to 1d, the heater 41 is controlled so as to make a temperature of the recording head 1a identical to a target temperature, and correspondingly to a measurement temperature of the temperature sensor 42, the controller 44 controls the switching element 43 and thereby causes current to flow through the heater 41, causes the heater 41 to generate heat, and raises a temperature of the recording head. In the normal status, the system-side switching element 73 of the host control system 61 is set in an ON status.

If malfunction occurs on the temperature sensor 42, then the measurement temperature may continue less than the target temperature, and thereby the current flow to the heater 41 may continue. Further, if malfunction occurs on the switching element 43 and thereby the switching element 43 can not turn to an OFF status, then the current flow to the heater 41 continues. Furthermore, if malfunction occurs on the controller 44 and thereby the switching element 43 turns to an ON status, then the current flow to the heater 41 continues. In these cases, the power supply control system in the recording head can not stop the current flow to the heater 41 autonomously.

Meanwhile, in the host control system 61, the main controller 71 watches whether a continuous current flow time of the current flow detected by the current detection unit 72 exceeds a predetermined value or not; and if the continuous current flow time exceeds the predetermined value, then the main controller 71 cuts off the current flow to the recording head using the system-side switching element 73. Consequently, even if the power supply control system in the recording head can not stop the current flow to the heater 41 autonomously, the host control system 61 forcibly stops the current flow to the heater 41.

As mentioned, in the aforementioned embodiment, the recording head 1a, 1b, 1c or 1d includes the heater 41, the temperature sensor 42, the switching element 43 on a power line to the heater 41, and the controller 44 that controls the switching element 43 on the basis of a measurement temperature of the temperature sensor 42 and thereby adjusts a temperature of the recording head. Further, in the host control system 61, the system-side switching element 73 is arranged on an upstream side of the power line from the switching element 43, the current detection unit 72 detects current flow in the power line, and if a continuous current flow time of the current flow detected by the current detection unit 72 exceeds a predetermined value, then the main controller 71 cuts of the current flow using the system-side switching element 73.

Consequently, even if malfunction occurs on the power supply control system in the recording head, abnormal temperature rise of the recording head is restrained.

It should be understood that various changes and modifications to the embodiments described herein will be apparent to those skilled in the art. Such changes and modifications may be made without departing from the spirit and scope of the present subject matter and without diminishing its intended advantages. It is therefore intended that such changes and modifications be covered by the appended claims.

What is claimed is:

1. An image forming apparatus, comprising:
a recording head configured to eject ink; and
a host control system configured to control recording head;
wherein the recording head comprises a heater, a temperature sensor, a switching element on a power line to the heater, and a controller configured to control the switching element on the basis of a measurement temperature of the temperature sensor and thereby control temperature of the recording head; and
the host control system comprises a current detection unit configured to detect a current that flows in the power line, a system-side switching element arranged on upstream side of the power line from the switching element, and a main controller configured to cut off the current using the system-side switching element if a continuous current flow time of the current detected by the current detection unit exceeds a predetermined value.

2. The image forming apparatus according to claim 1, wherein the predetermined value is set correspondingly to an upperlimit temperature of the ink in the recording head.
